(19) United States
(12) Patent Application Publication
(10) Pub. No.: US 2024/0403923 A1
(43) Pub. Date: Dec. 5, 2024

(54) USING GENERATIVE ARTIFICIAL INTELLIGENCE (AI) FOR AUTOMATED DIGITAL FLYER CONTENT GENERATION

(71) Applicant: Maplebear Inc., San Francisco, CA (US)

(72) Inventors: Bryan Pham, London (CA); Shaun Navin Maharaj, Vaughan (CA); Brent Scheibelhut, Toronto (CA); Mark Oberemk, Toronto (CA); Fabien Mouvet, Toronto (CA)

(21) Appl. No.: 18/677,640

(22) Filed: May 29, 2024

Related U.S. Application Data
(60) Provisional application No. 63/471,202, filed on Jun. 5, 2023.
(60) Provisional application No. 63/521,050, filed on Jun. 14, 2023.

(51) Int. Cl. G06Q 30/0241

(52) U.S. Cl. CPC G06Q 30/0276

(57) ABSTRACT

An online system generates digital flyers using a generative model. The online system receives, from a client device, a request to generate a digital flyer. The request includes one or more design conditions for the digital flyer. For example, the design conditions may specify one or more cornerstone items, a theme, a template flyer, other target characteristics, etc. The online system further accesses an item catalog storing item data. The online system generates a query for a generative model including a prompt to generate the digital flyer, the one or more design conditions, and item data accessed from the item catalog. The online system provides the query to a model serving system, which executes the generative model with the query to return a batch of one or more digital flyers. The online system provides a first digital flyer in the batch of one or more digital flyers for presentation.

### CROSS-REFERENCE TO RELATED APPLICATIONS

This application claims the benefit of U.S. Provisional Patent Application No. 63/521,050, filed on Jun. 14, 2023, and U.S. Provisional Patent Application No. 63/471,202, filed on Jun. 5, 2023, all of which are hereby incorporated by reference in their entirety.

### BACKGROUND

An online system is an online platform that connects users and retailers. A user can place an order for obtaining items, such as groceries, from participating retailers via the online system, with the shopping being done by a picker. After the picker finishes shopping, the order is delivered to the user's address. In some instances, the online system provides a communication interface that allows a user to communicate with a fulfillment user that is servicing the user's order. Oftentimes, a retailer distributes flyers, which advertise one or more items and provide information about the sale of those items to users of the online system.

Typically, retailers create weekly flyers to drive traffic. For example, the flyer may be built out to include a mix of cornerstone sales that attract a wide target audience and smaller sales that help either solidify the decision to shop or increase basket sizes after the cornerstone sale has gained attention from the requesting users. These flyers are generally built by retailer employees or operators, who make decisions about what items to promote and how in-depth based on a variety of factors such as historical order data, market knowledge, and intuition. The operators may then also generate additional material, such as visuals or creatives that are meant to make the flyer visually appealing to target demographics. This is an ongoing regular activity that requires time and effort from human retailer users.

### SUMMARY

An online system is an online platform that connects users and retailers. A requesting user can place an order for obtaining items, such as groceries, from participating fulfillment locations via the online system, with the item obtainment performed by a fulfillment user. After the fulfillment user completes item obtainment, the order with the obtained items may be delivered to a pre-specified location. In some instances, the online system provides a communication interface that allows a requesting user to communicate with a fulfillment user that is servicing the user's order.

The online system generates digital flyers using a generative model. An administrator of a fulfillment location may provide a general request with one or more design conditions. For example, the design conditions may specify one or more cornerstone items, a theme, a template flyer, other target characteristics, etc. The online system takes the general request with the design conditions and crafts a query to prompt a generative model. The online system may further access an item catalog storing item data offered at the fulfillment location. The online system generates the query for the generative model including a prompt to generate the digital flyer, the one or more design conditions, and item data accessed from the item catalog. The online system provides the query to a model serving system, which executes the generative model with the query to return a batch of one or more digital flyers. In some embodiments, the online system provides the batch of generated digital flyers to the administrator for selection or modification. The administrator may provide such selection or desired modifications. With desired modifications, the online system generates a subsequent query to the generative model instructing the generative model to modify the digital flyer according to the desired modifications. The online system may iterate with the administrator to refine the digital flyer. The online system provides the completed digital flyer for presentation.

In some embodiments, the online system may further augment the digital flyer with user-interactable elements. The online system applies an image segmentation model to the digital flyer to parse out image segments of the flyer. The image segmentation model may further classify image segments into different segment categories (e.g., a header, background, an image of an item, text information of an item, etc.). The online system subsequently applies an item matching model to match items in the item catalog to the image segments classified as pertaining to items. With the matched items, the online system may augment the flyer with user-interactable elements including the image segments and the matched items. In response to user interaction with the element, the user-interactable element may perform one or more actions related to the matched item (e.g., present additional details, provide an option to add to order, etc.).

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example process of generating flyers using generative machine-learned models, according to one or more embodiments.

FIG. 4 illustrates an example process of automating the generation of augmented flyers using a machine-learned model, in accordance with some embodiments.

FIG. 5 illustrates an example output from a segmentation model applied to an image flyer, according to one or more embodiments.

FIG. 6 is a method flowchart for generating flyers using generative machine-learned models, in accordance with some embodiments.

FIG. 7 is a method flowchart for automating the generation of augmented flyers using one or more machine-learned models, in accordance with some embodiments.

### DETAILED DESCRIPTION

### System Environment

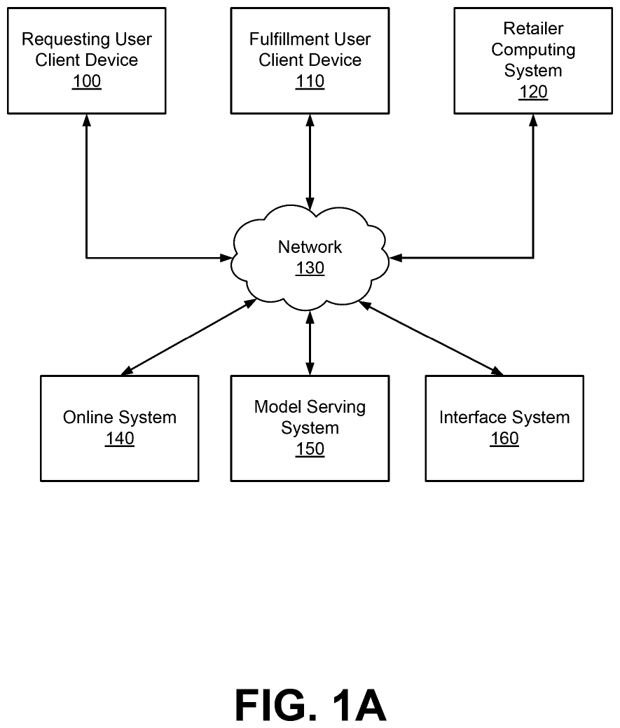

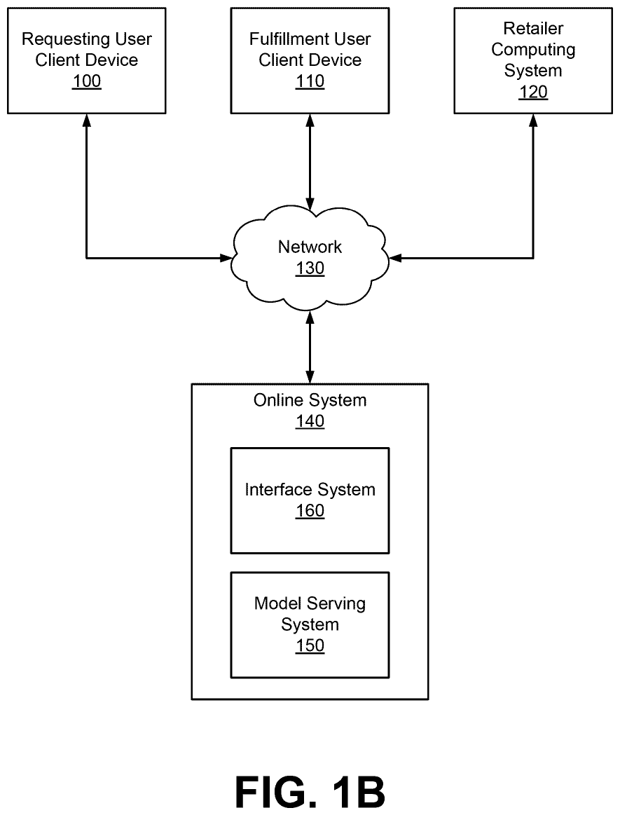

FIG. 1A illustrates an example system environment for an online system 140, in accordance with one or more embodiments. The system environment illustrated in FIG. 1A includes a requesting user client device 100, a fulfillment user client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, fulfillment users, and retailers may be generically referred to as “users” of the online system 140. Additionally, while one requesting user client device 100, fulfillment user client device 110, and retailer computing system 120 are illustrated in FIG. 1, any number of requesting users, fulfillment users, and retailers may interact with the online system 140. As such, there may be more than one requesting user client device 100, fulfillment user client device 110, or retailer computing system 120.

The requesting user client device 100 is a client device through which a requesting user may interact with the fulfillment user client device 110, the retailer computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. An order specifies a set of items to be delivered to the requesting user. An “item”, as used herein, means a good or product that can be provided to the requesting user through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The requesting user client device 100 presents an ordering interface to the requesting user. The ordering interface is a user interface that the requesting user can use to place an order with the online system 140. The ordering interface may be part of a client application operating on the requesting user client device 100. The ordering interface allows the requesting user to search for items that are available through the online system 140 and the requesting user can select which items to add to a “shopping list.” A “shopping list,” as used herein, is a tentative set of items that the user has selected for an order but that has not yet been finalized for an order. The ordering interface allows a requesting user to update the shopping list, e.g., by changing the quantity of items, adding or removing items, or adding instructions for items that specify how the item should be collected.

The requesting user client device 100 may receive additional content from the online system 140 to present to a requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a fulfillment user that is servicing the requesting user's order. This communication interface allows the user to input a text-based message to transmit to the fulfillment user client device 110 via the network 130. The fulfillment user client device 110 receives the message from the requesting user client device 100 and presents the message to the fulfillment user. The fulfillment user client device 110 also includes a communication interface that allows the fulfillment user to communicate with the requesting user. The fulfillment user client device 110 transmits a message provided by the fulfillment user to the requesting user client device 100 via the network 130. In some embodiments, messages sent between the requesting user client device 100 and the fulfillment user client device 110 are transmitted through the online system 140. In addition to text messages, the communication interfaces of the requesting user client device 100 and the fulfillment user client device 110 may allow the requesting user and the fulfillment user to communicate through audio or video communications, such as a phone call, a voice-over-IP call, or a video call.

The fulfillment user client device 110 is a client device through which a fulfillment user may interact with the requesting user client device 100, the retailer computing system 120, or the online system 140. The fulfillment user client device 110 can be a personal or mobile computing device, such as a smartphone, a tablet, a laptop computer, or desktop computer. In some embodiments, the fulfillment user client device 110 executes a client application that uses an application programming interface (API) to communicate with the online system 140.

The fulfillment user client device 110 receives orders from the online system 140 for the fulfillment user to service. A fulfillment user services an order by collecting the items listed in the order from a retailer. The fulfillment user client device 110 presents the items that are included in the requesting user's order to the fulfillment user in a collection interface. The collection interface is a user interface that provides information to the fulfillment user on which items to collect for a requesting user's order and the quantities of the items. In some embodiments, the collection interface provides multiple orders from multiple requesting users for the fulfillment user to service at the same time from the same retailer location. The collection interface further presents instructions that the requesting user may have included related to the collection of items in the order. Additionally, the collection interface may present a location of each item in the retailer location, and may even specify a sequence in which the fulfillment user should collect the items for improved efficiency in collecting items. In some embodiments, the fulfillment user client device 110 transmits to the online system 140 or the requesting user client device 100 which items the fulfillment user has collected in real time as the fulfillment user collects the items.

The fulfillment user can use the fulfillment user client device 110 to keep track of the items that the fulfillment user has collected to ensure that the fulfillment user collects all of the items for an order. The fulfillment user client device 110 may include a barcode scanner that can determine an item identifier encoded in a barcode coupled to an item. The fulfillment user client device 110 compares this item identifier to items in the order that the fulfillment user is servicing, and if the item identifier corresponds to an item in the order, the fulfillment user client device 110 identifies the item as collected. In some embodiments, rather than or in addition to using a barcode scanner, the fulfillment user client device 110 captures one or more images of the item and determines the item identifier for the item based on the images. The fulfillment user client device 110 may determine the item identifier directly or by transmitting the images to the online system 140. Furthermore, the fulfillment user client device 110 determines a weight for items that are priced by weight. The fulfillment user client device 110 may prompt the fulfillment user to manually input the weight of an item or may communicate with a weighing system in the retailer location to receive the weight of an item.

When the fulfillment user has collected all of the items for an order, the fulfillment user client device 110 instructs a fulfillment user on where to deliver the items for a requesting user's order. For example, the fulfillment user client device 110 displays a delivery location from the order to the fulfillment user. The fulfillment user client device 110 also provides navigation instructions for the fulfillment user to travel from the retailer location to the delivery location. Where a fulfillment user is servicing more than one order, the fulfillment user client device 110 identifies which items should be delivered to which delivery location. The fulfillment user client device 110 may provide navigation instructions from the retailer location to each of the delivery locations. The fulfillment user client device 110 may receive one or more delivery locations from the online system 140 and may provide the delivery locations to the fulfillment user so that the fulfillment user can deliver the corresponding one or more orders to those locations. The fulfillment user client device 110 may also provide navigation instructions for the fulfillment user from the retailer location from which the fulfillment user collected the items to the one or more delivery locations.

In some embodiments, the fulfillment user client device 110 tracks the location of the fulfillment user as the fulfillment user delivers orders to delivery locations. The fulfillment user client device 110 collects location data and transmits the location data to the online system 140. The online system 140 may transmit the location data to the requesting user client device 100 for display to the requesting user such that the requesting user can keep track of when their order will be delivered. Additionally, the online system 140 may generate updated navigation instructions for the fulfillment user based on the fulfillment user's location. For example, if the fulfillment user takes a wrong turn while traveling to a delivery location, the online system 140 determines the fulfillment user's updated location based on location data from the fulfillment user client device 110 and generates updated navigation instructions for the fulfillment user based on the updated location.

In one or more embodiments, the fulfillment user is a single person who collects items for an order from a retailer location and delivers the order to the delivery location for the order. Alternatively, more than one person may serve the role as a fulfillment user for an order. For example, multiple people may collect the items at the retailer location for a single order. Similarly, the person who delivers an order to its delivery location may be different from the person or people who collected the items from the retailer location. In these embodiments, each person may have a fulfillment user client device 110 that they can use to interact with the online system 140.

Additionally, while the description herein may primarily refer to fulfillment users as humans, in some embodiments, some or all of the steps taken by the fulfillment user may be automated. For example, a semi- or fully-autonomous robot may collect items in a retailer location for an order and an autonomous vehicle may deliver an order to a requesting user from a retailer location.

The retailer computing system 120 is a computing system operated by a retailer that interacts with the online system 140. As used herein, a “retailer” is an entity that operates a “retailer location,” which is a store, warehouse, or other building from which a fulfillment user can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The requesting user client device 100, the fulfillment user client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which requesting users can order items to be provided to them by a fulfillment user from a retailer. The online system 140 receives orders from a requesting user client device 100 through the network 130. The online system 140 selects a fulfillment user to service the requesting user's order and transmits the order to a fulfillment user client device 110 associated with the fulfillment user. The fulfillment user collects the ordered items from a retailer location and delivers the ordered items to the requesting user. The online system 140 may charge a requesting user for the order and provides portions of the payment from the requesting user to the fulfillment user and the retailer.

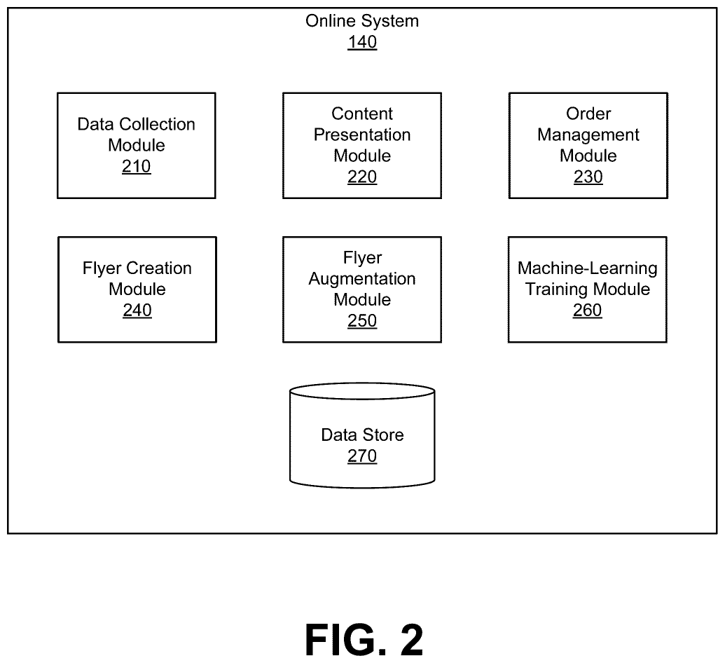

As an example, the online system 140 may allow a requesting user to order groceries from a grocery store retailer. The requesting user's order may specify which groceries they want delivered from the grocery store and the quantities of each of the groceries. The requesting user's client device 100 transmits the requesting user's order to the online system 140 and the online system 140 selects a fulfillment user to travel to the grocery store retailer location to collect the groceries ordered by the requesting user. Once the fulfillment user has collected the groceries ordered by the requesting user, the fulfillment user delivers the groceries to a location transmitted to the fulfillment user client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 performs an inference task in conjunction with the model serving system 150 to automatically generate and tune flyers around target goals associated with a retailer. In one or more embodiments, the model serving system 150 deploys an image or video generation model that receives a prompt and generates one or more images based on the prompt. In one or more embodiments, example target goals include creating a flyer around a cornerstone item, or a set of items, creating a flyer around items of specific brands, creating a flyer to attract attention to high-margin items for the retailer, and/or creating a flyer around a specific occasion or “theme” (e.g., cultural events). These target goals are not mutually exclusive, and the online system 140 incorporates balancing between different target goals via a weighting provided by a user associated with the retailer. In this manner, the retailer can prioritize different needs or target metrics as new flyers are generated at regular intervals.

In one or more embodiments, the online system 140 obtains base inputs, such as flyer parameters including media (e.g., image or video), size (e.g., size of image), theming variables like font or color choices for the creative, retailer location inventory data, retailer location historical sales data, retailer location demographic data, and/or retailer margins for specific items, and the like. In one instance, one or more of these base inputs are inferred from the online system 140. In another instance, one or more of these base inputs may be obtained from data already available to the online system 140 via an existing item catalog, retailer store list, and other data systems that have access to information about the retailer.

In one or more embodiments, the online system 140 uses base inputs described above to derive additional inputs, such as historical sales data of known retailer locations that match demographically to the specified retailer, forecasted trends for item sales based on identified sales that are in similar demographic areas, and/or correlations between specific items being sold together (e.g., “whole turkey” sales often driving roasting pan sales).

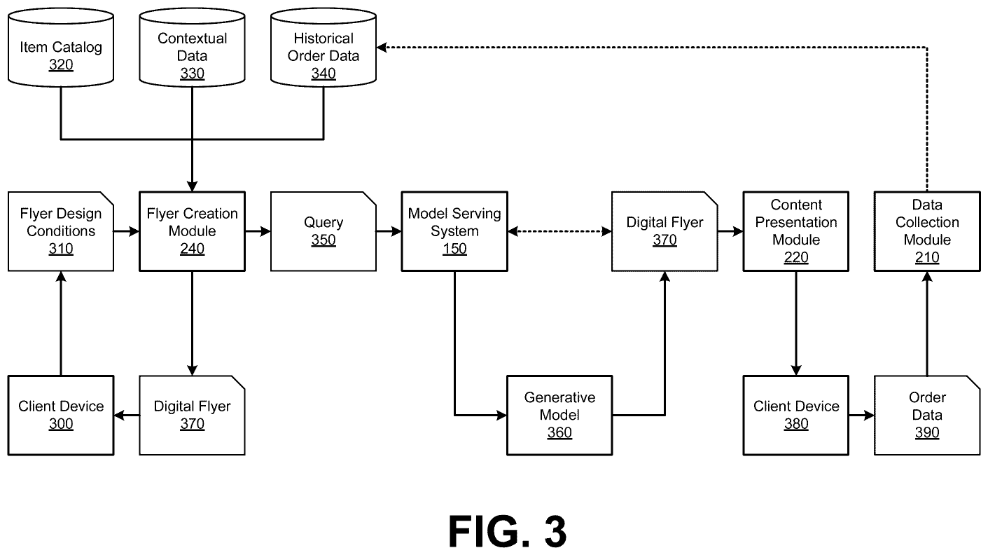

As a representative example, the online system 140 provides a request to generate a flyer based on one or more target goals and relative weightings between these goals specified by a user associated with a retailer (“user input” in FIG. 3). For example, the request may be formulated as:
“Build a flyer that optimizes for Chocolate creme sandwich cookies, or for Football Championship Weekend.”
   The online system 140 may obtain base inputs and/or additional inputs and provide the inputs for the retailer to the model serving system 150. The online system 140 obtains a flyer automatically generated from the model serving system 150 as a response to the request. For example, a response may be formulated as:
“Based on the data gathered, here is a flyer optimized for the sale of Chocolate creme sandwich cookies and other products in association with them for the upcoming Football Championship weekend. The flyer contains all varieties of Chocolate creme sandwich cookies, a Collection of Chocolate creme sandwich cookies of different flavors, and suggested offers based on the interest of Chocolate creme sandwich cookies.”
   with an automatically generated flyer attached.

In one or more embodiments, given the request and the inputs on the retailer, the model serving system 150 generates the flyer by using specified cornerstone items or any additional theme-based items. A cornerstone item may be an item identified by the retailer that is promoted with high priority due to, for example, large number of sales, brand importance, or other reasons that are important to the retailer. The model serving system 150 may use the specified weights and inputs to generate a ranked inventory of items to include in the flyer. Moreover, the model serving system 150 system generates a correlation score between items within that list to identify items that should be co-located within the page of a flyer or within generated creatives of the flyer.

The flyer layout is generated by generating creatives including one or more items based on the correlation scores and weightings specified by the user. A subset of creatives generated on the flyer may be laid out based on the given target weighting inputs. In one instance, any additional space within the flyer is filled with additional item listings that were ranked highly but not included in any creatives.

The model serving system 150 may also interface with an existing offers or discounts engine to recommend offers and discounts that may be applicable for the flyer item listings. In one instance, offer calculation will receive input from the prior input elements as the flyer generation as well. The model serving system 150 may create suggestions for the retailer to request potential discounts from their consumer-packaged goods (CPGs) for items listed in the generated catalog. This process is based on the evidence of how items are projected to perform via the generated catalog.

In one or more embodiments, the flyer generation process is repeated a number of times to generate a number of flyer options or variants for the retailer to select from. The retailer may then accept one of the given options and publish the selected flyer and/or restart the generation process to alter inputs or target goal weightings if desired.

In this manner, users associated with retailers can direct macro or strategic decisions (e.g., cornerstone items) generation of the digital flyer (e.g., additional items to add to the marketing material, page arrangement of the flyer) is performed by the machine-learned generative model. The machine-learned generation model also has a broader set of information to pull from, with awareness of potentially relevant factors for flyer generation. This allows the model to make more informed decisions than a human operator might, including decisions based on information (e.g., margins, sales data in other markets, upcoming trends) that a creative director might not be directly aware of or remember.

In one or more embodiments, the online system 140 further refines the process for generating flyers by iteratively incorporating feedback and analytics of the generated flyer after the generated flyer has been published by the retailer. The feedback information for the generated flyer may include metrics such as tracking conversion metrics, impressions, performance of click-through rates (CTRs) on augmented versions of the flyers, and the like. These metrics may also be added as input to improve the generative model.

These inputs may be used to improve the models which generate the flyers for subsequent intervals. For example, the online system 140 keeps track of CTRs, conversion metrics, and the like of items presented in the flyer, and sets the metrics into a separate storage. The collected analytics of the flyer is provided to the model serving system 150 to update the rankings or weights of items in the catalog. The correlation scores may also be re-calculated based on the updated weights, and the continuous feedback on the generated flyers.

In one or more embodiments, the online system 140 performs an inference task in conjunction with the model serving system 150 to automatically augment flyers. An augmented flyer allows users to interact with different portions of the flyer to perform one or more desired actions. For example, the user may click on an item in the flyer, and responsive to the interaction, the online system 140 directs the user to an ordering interface that allows the user to view details on the item and add the item to the user's cart. In one or more embodiments, the online system 140 receives a flyer (e.g., in image form or as a PDF) from a retailer that describes one or more items for sale by the retailer and other information on the items.

The online system 140 augments the flyer by identifying one or more interactable regions in the flyer, for example, regions that are clickable by a user. In one or more embodiments, the online system 140 identifies a set of elements of the flyer using one or more machine-learned models. As described in more detail below, the elements may include a header or banner indicating the name of the retailer, flyer cells including items for promotion, and the like. The online system 140 then matches or associates an interactable region of the flyer with an item in the catalogue or database of the online system 140. Thus, when a user clicks or interacts with the interactable region, the online system 140 can perform one or more desired actions, such as redirecting the user to an ordering interface where the user can order the item selected in the flyer.

Specifically, flyers may be an important part of promoting items for the online system 140 and may have a significant number of visitors and users. Moreover, retailers may use flyers to highlight in-store or online store deals. While one way to augment flyers is for human operators to identify the different elements of the flyer in the image, associate the promoted items with the items in the catalog, this may be error-prone and involve a significant number of resources. By automating the augmentation of flyers using machine-learned models, the online system 140 can greatly improve the number of resources that go into matching items in a flyer with actual items in a catalog. Moreover, automating the augmenation using machine-learned models may also help to reduce error rates compared to when human operators manually augment flyers.

FIG. 1B illustrates an example system environment for an online system 140, in accordance with one or more embodiments. The system environment illustrated in FIG. 1B includes a requesting user client device 100, a fulfillment user client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

### Online System Architecture

FIG. 2 illustrates an example system architecture for an online system 140, in accordance with some embodiments. The system architecture illustrated in FIG. 2 includes a data collection module 210, a content presentation module 220, an order management module 230, a flyer creation module 240, a flyer augmentation module 250, a machine-learning training module 260, and a data store 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online system 140 and stores the data in the data store 270. The data collection module 210 may only collect data describing a user if the user has previously explicitly consented to the online system 140 collecting data describing the user. Additionally, the data collection module 210 may encrypt all data, including sensitive or personal data, describing users.

For example, the data collection module 210 collects requesting user data, which is information or data that describe characteristics of a requesting user. Requesting user data may include a requesting user's name, address, shopping preferences, favorite items, or stored payment instruments. The requesting user data also may include default settings established by the requesting user, such as a default retailer/retailer location, payment instrument, delivery location, or delivery timeframe. The data collection module 210 may collect the requesting user data from sensors on the requesting user client device 100 or based on the requesting user's interactions with the online system 140.

The data collection module 210 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include ordering rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a fulfillment user looked for the item but could not find it), the rate at which the item is found, or the popularity of the item. The data collection module 210 may collect item data from a retailer computing system 120, a fulfillment user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 210 also collects fulfillment user data, which is information or data that describes characteristics of fulfillment users. For example, the fulfillment user data for a fulfillment user may include the fulfillment user's name, the fulfillment user's location, how often the fulfillment user has services orders for the online system 140, a requesting user rating for the fulfillment user, which retailers the fulfillment user has collected items at, or the fulfillment user's previous shopping history. Additionally, the fulfillment user data may include preferences expressed by the fulfillment user, such as their preferred retailers to collect items at, how far they are willing to travel to deliver items to a requesting user, how many items they are willing to collect at a time, timeframes within which the fulfillment user is willing to service orders, or payment information by which the fulfillment user is to be paid for servicing orders (e.g., a bank account). The data collection module 210 collects fulfillment user data from sensors of the fulfillment user client device 110 or from the fulfillment user's interactions with the online system 140.

Additionally, the data collection module 210 collects order data, which is information or data that describes characteristics of an order. For example, order data may include item data for items that are included in the order, a delivery location for the order, a requesting user associated with the order, a retailer location from which the requesting user wants the ordered items collected, or a timeframe within which the requesting user wants the order delivered. Order data may further include information describing how the order was serviced, such as which fulfillment user serviced the order, when the order was delivered, or a rating that the requesting user gave the delivery of the order. In some embodiments, the order data includes user data for users associated with the order, such as requesting user data for a requesting user who placed the order or fulfillment user data for a fulfillment user who serviced the order.

In one or more embodiments, the data collection module 210 also collects communication data, which is different types of communication between shoppers and users of the online system 140. For example, the data collection module 210 may obtain text-based, audio-call, video-call based communications between different shoppers and users of the online system 140 as orders are submitted and fulfilled. The data collection module 210 may store the communication information by individual user, individual shopper, per geographical region, per subset of users having similar attributes, and the like.

In one or more embodiments, the data collection module 210 may collect data relating to user interaction with digital flyers, e.g., generated by the flyer creation module 240, automatically augmented by the flyer augmentation module 250, presented by the content presentation module 220, or some combination thereof. The data collection module 210 may measure metrics related to the user interaction such as length of time viewing the flyer, items interacted with, items added (e.g., to a shopping list, to a favorite list, or to an order), other metrics related to viewing of the digital flyer and/or interacting with items represented in the digital flyer. The data collection module 210 may provide the flyer interaction data to the data store 270 and/or to the machine-learning training module 260 for training or tuning of one or more machine-learning models related to flyer management.

The content presentation module 220 selects content for presentation to a requesting user. For example, the content presentation module 220 selects which items to present to a requesting user while the requesting user is placing an order. The content presentation module 220 generates and transmits the ordering interface for the requesting user to order items. The content presentation module 220 populates the ordering interface with items that the requesting user may select for adding to their order. In some embodiments, the content presentation module 220 presents a catalog of all items that are available to the requesting user, which the requesting user can browse to select items to order. The content presentation module 220 also may identify items that the requesting user is most likely to order and present those items to the requesting user. For example, the content presentation module 220 may score items and rank the items based on their scores. The content presentation module 220 displays the items with scores that exceed some threshold (e.g., the top n items or the p percentile of items).

The content presentation module 220 may use an item selection model to score items for presentation to a requesting user. An item selection model is a machine learning model that is trained to score items for a requesting user based on item data for the items and requesting user data for the requesting user. For example, the item selection model may be trained to determine a likelihood that the requesting user will order the item. In some embodiments, the item selection model uses item embeddings describing items and requesting user embeddings describing requesting users to score items. These item embeddings and requesting user embeddings may be generated by separate machine learning models and may be stored in the data store 270.

In some embodiments, the content presentation module 220 scores items based on a search query received from the requesting user client device 100. A search query is free text for a word or set of words that indicate items of interest to the requesting user. The content presentation module 220 scores items based on a relatedness of the items to the search query. For example, the content presentation module 220 may apply natural language processing (NLP) techniques to the text in the search query to generate a search query representation (e.g., an embedding) that represents characteristics of the search query. The content presentation module 220 may use the search query representation to score candidate items for presentation to a requesting user (e.g., by comparing a search query embedding to an item embedding).

In some embodiments, the content presentation module 220 scores items based on a predicted availability of an item. The content presentation module 220 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 220 may weight the score for an item based on the predicted availability of the item. Alternatively, the content presentation module 220 may filter out items from presentation to a requesting user based on whether the predicted availability of the item exceeds a threshold.

In one or more embodiments, the content presentation module 220 receives one or more recommendations for presentation to the requesting user while the requesting user is engaged with the ordering interface. The list of ordered items of a requesting user may be referred to as a basket. As described in conjunction with FIGS. 1A and 1B, the recommendations are generated based on the inferred purpose of the basket of the requesting user and include one or more suggestions to the requesting user to better fulfill the purpose of the basket.

In one or more embodiments, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 220 may present the equivalent basket to the requesting user via the ordering interface with an indicator that states how an equivalent basket improves or is different from the existing basket (e.g., more cost-effective, healthier, sponsored by a certain organization). The content presentation module 220 may allow the requesting user to swap the existing basket with an equivalent basket.

In one or more embodiments, when the basket includes a list of edible ingredients, the recommendations are in the form of a list of potential recipes the ingredients can fulfill, and a list of additional ingredients to fulfill each recipe. The content presentation module 220 may present each suggested recipe and the list of additional ingredients for fulfilling the recipe to the requesting user. The content presentation module 220 may allow the requesting user to automatically place one or more additional ingredients in the basket of the requesting user.

In one or more embodiments, the content presentation module 220 may provide flyers prepared by the online system 140 to client devices for presentation to users of the online system 140. In one or more embodiments, the content presentation module 220 provides digital flyers generated by the flyer creation module 240, e.g., using a generative machine-learning model. In one or more embodiments, the content presentation module 220 provides an augmented flyer generated by the flyer augmentation module 250, e.g., using one or more machine-learning models to link items represented in a flyer to items in an item catalog. In one or more embodiments, the augmented flyer may be a digital flyer generated by the flyer creation module 240 that is subsequently augmented by the flyer augmentation module 250. With augmented flyers, as a user interacts with an item represented in the augmented flyer, the content presentation module 220 may respond with one or more actions, e.g., maximizing a view of the item, providing additional user-interactable options (e.g., add to list, add to order, view similar items, see promotions, etc.).

The order management module 230 that manages orders for items from requesting users. The order management module 230 receives orders from a requesting user client device 100 and assigns the orders to fulfillment users for service based on fulfillment user data. For example, the order management module 230 assigns an order to a fulfillment user based on the fulfillment user's location and the location of the retailer from which the ordered items are to be collected. The order management module 230 may also assign an order to a fulfillment user based on how many items are in the order, a vehicle operated by the fulfillment user, the delivery location, the fulfillment user's preferences on how far to travel to deliver an order, the fulfillment user's ratings by requesting users, or how often a fulfillment user agrees to service an order.

In some embodiments, the order management module 230 determines when to assign an order to a fulfillment user based on a delivery timeframe requested by the requesting user with the order. The order management module 230 computes an estimated amount of time that it would take for a fulfillment user to collect the items for an order and deliver the ordered item to the delivery location for the order. The order management module 230 assigns the order to a fulfillment user at a time such that, if the fulfillment user immediately services the order, the fulfillment user is likely to deliver the order at a time within the timeframe. Thus, when the order management module 230 receives an order, the order management module 230 may delay in assigning the order to a fulfillment user if the timeframe is far enough in the future.

When the order management module 230 assigns an order to a fulfillment user, the order management module 230 transmits the order to the fulfillment user client device 110 associated with the fulfillment user. The order management module 230 may also transmit navigation instructions from the fulfillment user's current location to the retailer location associated with the order. If the order includes items to collect from multiple retailer locations, the order management module 230 identifies the retailer locations to the fulfillment user and may also specify a sequence in which the fulfillment user should visit the retailer locations.

The order management module 230 may track the location of the fulfillment user through the fulfillment user client device 110 to determine when the fulfillment user arrives at the retailer location. When the fulfillment user arrives at the retailer location, the order management module 230 transmits the order to the fulfillment user client device 110 for display to the fulfillment user. As the fulfillment user uses the fulfillment user client device 110 to collect items at the retailer location, the order management module 230 receives item identifiers for items that the fulfillment user has collected for the order. In some embodiments, the order management module 230 receives images of items from the fulfillment user client device 110 and applies computer-vision techniques to the images to identify the items depicted by the images. The order management module 230 may track the progress of the fulfillment user as the fulfillment user collects items for an order and may transmit progress updates to the requesting user client device 100 that describe which items have been collected for the requesting user's order.

In some embodiments, the order management module 230 tracks the location of the fulfillment user within the retailer location. The order management module 230 uses sensor data from the fulfillment user client device 110 or from sensors in the retailer location to determine the location of the fulfillment user in the retailer location. The order management module 230 may transmit to the fulfillment user client device 110 instructions to display a map of the retailer location indicating where in the retailer location the fulfillment user is located. Additionally, the order management module 230 may instruct the fulfillment user client device 110 to display the locations of items for the fulfillment user to collect, and may further display navigation instructions for how the fulfillment user can travel from their current location to the location of a next item to collect for an order.

The order management module 230 determines when the fulfillment user has collected all of the items for an order. For example, the order management module 230 may receive a message from the fulfillment user client device 110 indicating that all of the items for an order have been collected. Alternatively, the order management module 230 may receive item identifiers for items collected by the fulfillment user and determine when all of the items in an order have been collected. When the order management module 230 determines that the fulfillment user has completed an order, the order management module 230 transmits the delivery location for the order to the fulfillment user client device 110. The order management module 230 may also transmit navigation instructions to the fulfillment user client device 110 that specify how to travel from the retailer location to the delivery location, or to a subsequent retailer location for further item collection. The order management module 230 tracks the location of the fulfillment user as the fulfillment user travels to the delivery location for an order, and updates the requesting user with the location of the fulfillment user so that the requesting user can track the progress of their order. In some embodiments, the order management module 230 computes an estimated time of arrival for the fulfillment user at the delivery location and provides the estimated time of arrival to the requesting user.

In some embodiments, the order management module 230 facilitates communication between the requesting user client device 100 and the fulfillment user client device 110. As noted above, a requesting user may use a requesting user client device 100 to send a message to the fulfillment user client device 110. The order management module 230 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner.

The order management module 230 coordinates payment by the requesting user for the order. The order management module 230 uses payment information provided by the requesting user (e.g., a credit card number or a bank account) to receive payment for the order. In some embodiments, the order management module 230 stores the payment information for use in subsequent orders by the requesting user. The order management module 230 computes a total cost for the order and charges the requesting user that cost. The order management module 230 may provide a portion of the total cost to the fulfillment user for servicing the order, and another portion of the total cost to the retailer.

### Generation of Digital Flyers Using Machine-Learned Generative Models

The flyer creation module 240 generates one or more digital flyers using a generative machine-learning model. In one or more embodiments, the generative machine-learning model is deployed by the model serving system 150 and is configured as a multi-modal transformer architecture with one or more attention (e.g., self-attention or cross-attention) layers. The flyer creation module 240 receives user input to guide the flyer generation. The user input may include a number of flyer design conditions. For example, the user, via a client device, may provide input to craft a flyer around one or more cornerstone items. In such embodiments, the design conditions may include the cornerstone items. In another example, the user, via the client device, may provide input to craft a flyer that celebrates a season, a holiday, an event, etc. In such embodiments, the design conditions may include those themes. In other examples, the user, via the client device, may provide other design conditions that describe a target characteristic of the flyer, e.g., number of items shown in the flyer, density, packing configuration, flyer layout, number of pages, flow of item categories (e.g., first page designated for one item category, second page top half designated to a second item category, second page bottom half designated to a third item category), etc.

The flyer creation module 240 generates a query for a generative model to generate a flyer based on the design conditions provided in the user input. The flyer creation module 240 may generate the query to further indicate other instructions based on item information, contextual data about the flyer generation process (e.g., a season, upcoming events, promotions on items, etc.), historical order data (e.g., item trends, etc.), or some combination thereof. The flyer creation module 240 provides the query to the model serving system 150 to execute with the generative model. The generative model returns one or more digital flyers generated according to the query.

The flyer creation module 240 may return the digital flyers to a user of the client device for review and selection. For example, the language model may return a batch of flyers that each satisfy the design conditions. The flyer creation module 240 may provide the batch of flyers for selection and/or modification by the user. The user may, via the client device, provide input selecting one of the flyers in the generated batch. The user may, via the client device, further provide an input describing one or more modifications to make to a flyer. For example, the user may provide input to combine the first page of flyer one with the subsequent pages of flyer two. In another example, the user may provide input to change a layout of items presented in the first page of a flyer. Based on the subsequent user input, the flyer creation module 240 may generate a subsequent query with the one or more modifications. The flyer creation module 240 may provide the subsequent query to the model serving system 150 for execution by the generative model. The flyer creation module 240 may further iterate modifying the flyer. The flyer creation module 240 provides the completed flyer to the content presentation module 220 for presentation. In some embodiments, the generated flyer may be provided to the flyer augmentation module 250 to augment the flyer.

In some embodiments, the generative model is a machine-learning language model. The language model may receive text tokens as input and may output the digital flyer as image data. In some embodiments the machine-learning language model maintains a corpus of data relating to item information, e.g., derived from an item catalog. In other embodiments, the flyer creation module 240 may provide contextual information, such as the item information in the item catalog, in the query to the machine-learning language model. In some embodiments, the generative model is multimodal, capable of receiving and/or outputting data in a plurality of forms.

In one or more embodiments, the flyer creation module 240, in conjunction with the language model, generates multimodal flyers. Multimodality generally refers to the ability to a plurality of modes of data. For example, the multimodal flyer can include content in a plurality of modes of data, e.g., image mode, text mode, audio speech or audio content, video mode, etc. The language model may also receive multimodal inputs, e.g., a text query that requests generation of a flyer with one or more data objects representing items in the item catalog. In other examples, the language model may receive a template flyer to serve as a template to generate a new flyer with cornerstone items described in the text query. In other examples, the query may be an audio query by a user, etc.

In one or more embodiments, the flyer creation module 240 obtains training data for fine-tuning parameters of the generative machine-learning model based on the feedback data. In one or more embodiments, the flyer creation module 240 identifies instances where users provided positive feedback on generated flyers, for example, flyers that obtained high CTR's, conversion metrics, and the like. For example, a data instance in the training data includes one or more queries or prompts used to generate the flyer, other base or contextual inputs, and the like, and a corresponding flyer that was created in image or video format (e.g., JPEG, PNG). The flyer may be represented as one or more image tokens or latent tokens that each represent a respective region of the image or video.

During the training process, the flyer creation module 240 applies parameters of the machine-learned generation model to the prompt of a training instance to generate a set of estimated output tokens. The flyer creation module 225 compares the estimated output tokens with the corresponding tokens for the flyer of the training instance to compute a loss function. The flyer creation module 225 obtains one or more error terms from the loss function, and backpropagates the error terms to update the parameters of the machine-learned model.

### Augmentation of Flyers Using Machine-Learned Generative Models

The flyer augmentation module 250 augments flyers to include user-interactable elements. The flyer augmentation module 250 obtains an image flyer. The image flyer may be a digital form of a flyer (e.g., generated by a retailer, or by the flyer creation module 240), a scanned form of a paper flyer (e.g., scanned with a scanner, or an image captured by a camera assembly (e.g., on a client device)). The image flyer may include images and/or text describing items presented in the flyer. A user-interactable element may be a portion of the flyer that can be interacted with by a user presented with the augmented version of the flyer to perform one or more desired actions (e.g., view additional details of an item, direct to ordering interface for ordering item).

The flyer augmentation module 250 applies a segmentation model to segment the image flyer into a plurality of image segments. Image segmentation generally is a computer vision technique that partitions a digital image into discrete groups of pixels, i.e., image segments, to inform object detection and related tasks. For example, the segmentation model may segment the flyer into one image segment representing a header (i.e., that describes the retailer and associated information), another image segment representing background, one or more image segments representing individual items, one or more image segments representing item information in text form, etc. The segmentation model may be a machine-learning model that is trained in a supervised or unsupervised fashion. For example, in a supervised fashion, the segmentation model may be trained on annotated flyers. The annotations may indicate the segmentation of the flyer, e.g., provided by a human annotator. The segmentation model is trained with the annotated training data to accurately infer the ground truth segmentation. In some embodiments, the segmentation model may include a classification model that classifies the image segments into the segment categories. In some embodiments, the segmentation model is trained to segment the image flyer into flyer cells, each flyer cell including a bounding box within which items and item information is depicted.

The flyer augmentation module 250 applies an item matching model to image segments categorized under a segment category relating to items presented in the flyer, in order to match the image segments to items in the item catalog. The item matching model may implement an object recognition algorithm that calculates a similarity score between the image segment with images for the items in the item catalog. The object recognition algorithm may calculate the similarity score based on features in the image segment and features in an image of an item, e.g., corners, edges, written text, color, etc. For example, if the two feature sets are vastly different, the object recognition algorithm returns a low similarity score. In another example, if the two feature sets have a large overlap in features, then the object recognition algorithm returns a high similarity score.

The object recognition algorithm may be a machine-learning model configured to receive an image and generate an estimate indicating the item identifier that the item should be mapped to in the catalog. For example, the flyer augmentation module 250 may provide item images from the flyer that correspond to the image segments to map each item to a corresponding item identifier SKU. In such embodiments, the item matching model may select the item in the item catalog with the highest calculated similarity score as the item that matches the image segment. The item matching model may link the image segment to the matched item. In some embodiments, if similarity scores are below a threshold, the item matching model may determine that there is no item in the item catalog that matches to the image segment.

In some embodiments, the item matching model may further leverage insights from natural language processing of text in the one or more image segments. For example, in proximity to an image segment relating to an image of an item may be an image segment relating to information relating to the same item in text form. The item matching model may leverage natural language processing to infer or to corroborate the determination of what item in the catalog is represented by one or more image segments. The item matching model may determine the similarity score as an aggregation of the image comparison and the text inference.

In one or more embodiments, the flyer augmentation module 250 may store the ordering data of items in advance so a price or an available promotion for the items is already known. The flyer augmentation module 250 can correlate this information with the text data extracted from the identified elements (or sub-elements) of the flyer to match the interactable regions to item identifiers of known items in the stored catalog. For example, the flyer augmentation module 250 may compare the publication time frame of the flyer with the known sale durations of items to match the interactable region with one or more items. In general, the flyer augmentation module 250 may compare text data extracted from the flyer with information of the mapped items in the catalog (e.g., sale price, sale duration, offer details) to verify that the interactable region should be mapped to those items.

In one or more embodiments, human operators may refine estimates from the segmentation model, or the item matching model that have low confidence scores (e.g., confidence scores below a predetermined threshold value) or have incorrect outputs. The flyer augmentation module 250 may incorporate the corrections or other feedback received from the human operators to fine-tune the models by, for example, incorporating the feedback information into the training data.

The flyer augmentation module 250 augments the flyer with user-interactable elements based on the image segments and the matched items. In one or more embodiments, the user-interactable element transforms the image segment relating to a matched item to be a clickable region. As the flyer is presented via a client device associated with a user, the user may click on the clickable region. Upon clicking (or otherwise interacting with the user-interactable element), the user-interactable element may perform one or more follow-up actions. For example, upon clicking, the user-interactable element may magnify a view of the image segment and display options for further actions in conjunction with the item matched to the image segment. In one example, the user-interactable element may include an “Add to Order” option that, responsive to the user selecting the option, adds the item matched to the user-interactable element to a user's order. In another example, the user-interactable element may include a “View Suggested Recipe” option that, responsive to the user selecting the option, can further display one or more recipes associated with the item matched to the image segment. In another example, the user-interactable element may include a “See Available Promotions” option that, responsive to the user selecting the option, can crosscheck whether a promotion is available for the item. If an available promotion is available for the item, the user-interactable element may display the promotion.

The flyer augmentation module 250 provides the augmented flyer to the content presentation module 220 for presentation to one or more users. In one or more embodiments, the online system 140 may coordinate or host services related to a plurality of retailers. The online system 140 may obtain image flyers from each of the retailers to augment the flyers for use in conjunction with the online system 140.

The machine learning training module 260 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 260 generates the set of parameters for a machine learning model by “training” the machine learning model. Once trained, the machine learning model uses the set of parameters to transform inputs into outputs.

The machine learning training module 260 trains a machine learning model based on a set of training examples. Each training example includes input data to which the machine learning model is applied to generate an output. For example, each training example may include requesting user data, fulfillment user data, item data, or order data. In some cases, the training examples also include a label which represents an expected output of the machine learning model. In these cases, the machine learning model is trained by comparing its output from input data of a training example to the label for the training example.

The machine learning training module 260 may apply an iterative process to train a machine learning model whereby the machine learning training module 260 trains the machine learning model on each of the set of training examples. To train a machine learning model based on a training example, the machine learning training module 260 applies the machine learning model to the input data in the training example to generate an output. The machine learning training module 260 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 260 updates the set of parameters for the machine learning model based on the score generated by the loss function. For example, the machine learning training module 260 may apply gradient descent to update the set of parameters.

The data store 270 stores data used by the online system 140. For example, the data store 270 stores requesting user data, item data, order data, and fulfillment user data for use by the online system 140. The data store 270 also stores trained machine learning models trained by the machine learning training module 260. For example, the data store 270 may store the set of parameters for a trained machine learning model on one or more non-transitory, computer-readable media. The data store 270 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 260 may further train parameters of the machine-learned model based on data specific to the online system 140 stored in the data store 270. As an example, the machine-learning training module 260 may obtain a pre-trained transformer language model and further fine tune the parameters of the transformer model using training data stored in the data store 270. The machine-learning training module 260 may provide the model to the model serving system 150 for deployment.

### Illustrative Flowcharts

FIG. 3 illustrates an example process of generating flyers using generative machine-learned models, according to one or more embodiments. The example process illustrated in FIG. 3 is described as being performed by the online system 140, and its various modules and components. In other embodiments, other systems or devices may perform some or all of the steps described.

A client device 300 provides user input including flyer design conditions 310 to the online system 140 to generate a digital flyer. The client device 300 may be associated with a retailer hosted by the online system 140 and/or an administrator for the online system 140. The flyer creation module 240 receives the flyer design conditions 310 and generates a query 350 based on the flyer design conditions. The flyer creation module 240 may further include additional instructions in the query 350 based on item information obtained from an item catalog 320, contextual data 330 (e.g., a current season, ordering trends, upcoming events, etc.), and historical order data 340 (e.g., obtained by a data collection module 210).

The flyer creation module 240 provides the query 350 to the model serving system 150, which serves the query 350 to a generative model 360 for execution. The generative model 360 provides a digital flyer 370 in response to execution of the query 350. The model serving system 150 may provide the digital flyer 370 (or batch of flyers) to the flyer creation module 240, which may provide the digital flyer 370 back to the client device 300 for approval and/or modification.

In some embodiments, the client device 300 may choose from the generated digital flyers. In other embodiments, the client device 300 may provide subsequent user input with one or more modifications to the digital flyer 370. The flyer creation module 240 may iteratively modify and provide the modified digital flyer 370 to the client device 300 for approval and/or modification.

The completed digital flyer 370 is provided to the content presentation module 220 for provision to a client device 380 to present to the user. The client device 380 may be associated with a user placing an order to be fulfilled by the online system 140. Upon viewing the digital flyer 370, the client device 380 may place an order with the online system 140.

The data collection module 210 may collect data associated with the order data 390, which may be stored as historical order data 340. The historical order data 340 may also be used to inform the flyer creation process in a feedback loop. The machine-learning training module 260 may determine correlations between items presented in the digital flyer 370 and items ordered in the order data 390. Based on such correlations, the machine-learning training module 260 may tune the generative model 360's flyer generation. For example, the machine-learning training module 260 may seek to maximize user interaction with cornerstone items indicated in the flyer design conditions 310. In another example, the machine-learning training module 260 may learn correlations between positions on the digital flyer and user interaction, which may inform placement of items in the generated flyer.

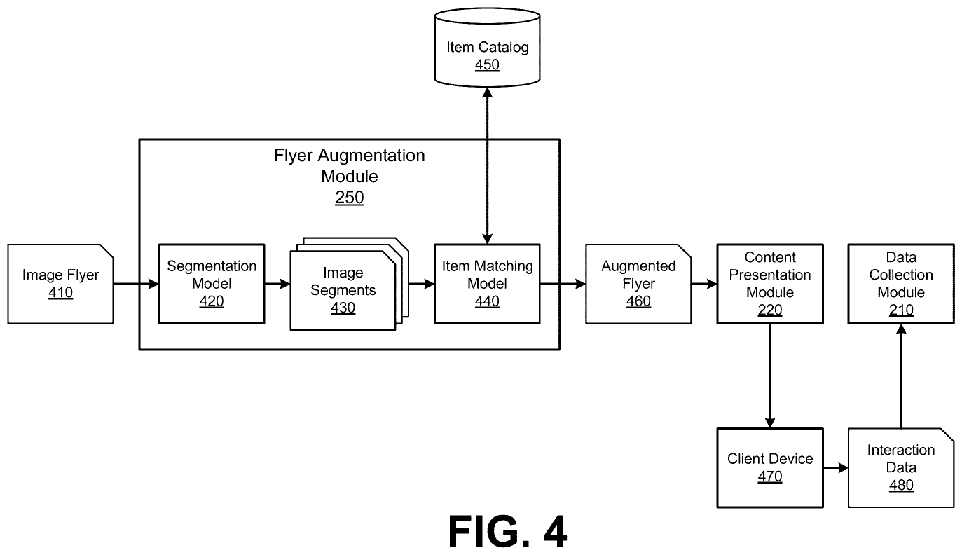

FIG. 4 illustrates an example process of automated generation of augmented flyers using a machine-learned model, in accordance with some embodiments. The example process illustrated in FIG. 4 is described as being performed by the online system 140, and its various modules and components. In other embodiments, other systems or devices may perform some or all of the steps described.

The online system 140 receives an image flyer 410 that is non-interactable, or perhaps limited in digital interaction functionality. The flyer augmentation module 250 applies a segmentation model 420 to the image flyer 410 to determine image segments 430. The segmentation model 420 groups pixels together relating to each image segment 430. The segmentation model 420 may further classify image segments 430 into one of a plurality of segment categories, e.g., background, header, item image, item information, retailer information, etc.

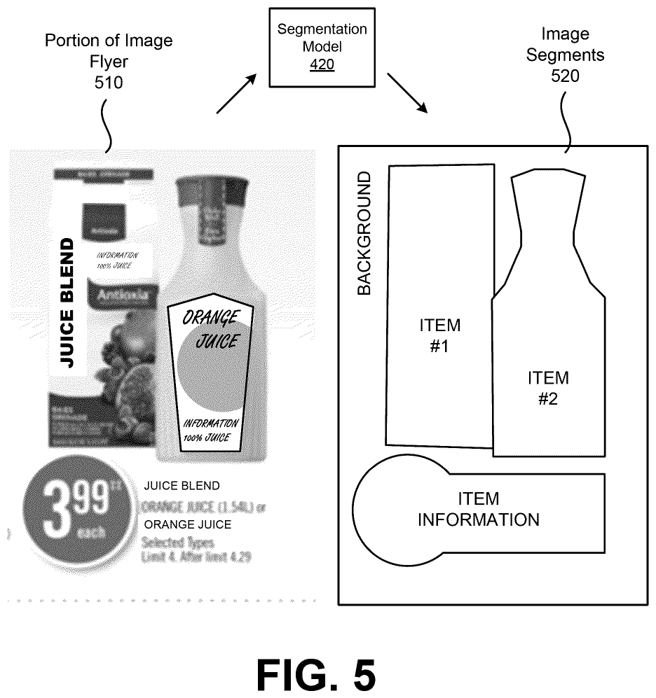

FIG. 5 illustrates an example output from a segmentation model 420 applied to a portion of an image flyer 510, according to one or more embodiments. The segmentation model 420 parses the portion of the image flyer 510 to determine image segments 520. An image segment is a grouping of pixels. In the example shown, the portion of the image flyer 510 is parsed into four image segments 520. One image segment relates to a first item, another image segment relates to a second item, a third image segment relates to item information, and a fourth image segment relates to the background of the flyer.

Referring back to FIG. 4, the item matching model 440 matches image segments depicting or describing items to items in the item catalog 450. The item matching model 440 may apply an image classification algorithm to image segments showing an image of the item and/or a natural language processing algorithm to image segments with text describing the item to match the image segments to the items in the item catalog. In the example shown in FIG. 5, the image classification model 440 may apply the image classification algorithm to image segments including the images of the items, whereas the natural language processing algorithm may be applied to the image segment relating to item information. In some instances, the item information may refer to a plurality of items. Accordingly, the natural language processing algorithm may identify the plurality of items referenced in the text of the item information. For example, a text recognition algorithm, such as optical character recognition (OCR), can be applied to extract text data from the various elements of the flyer. For example, for a given flyer cell that is promoting the two juice items, the item matching model 440 can perform OCR on the price sub-element to extract text data that indicates the price is $3.99 for each juice item and the label sub-element to extract any item descriptions (e.g., “ABC Orange Juice, 1.5 L and DEF Juice Blend, 1.5 L”) from the cell.

The flyer augmentation model 440 generates the user-interactable elements in the augmented flyer 460 with the image segments 430 and the matched items. A user-interactable element may include an image segment 430 as a clickable (or any other user-interactable form) region. As the user clicks or interacts with the image segment 430, the augmented flyer 460 may perform one or more actions responsive to the user interaction. For example, a user clicks on a user-interactable element depicting an image of an item. In response, the augmented flyer 460 can magnify the image of the item and may further present additional options for interacting with the item, e.g., add to order, add to list, view suggested recipes, view similar products, view available promotions, etc.

The flyer augmentation module 250 provides the augmented flyer 460 to the content presentation module 220 for provision to a client device 470 to present to the user. The client device 470 may be associated with a user placing an order to be fulfilled by the online system 140. The client device 470 may interact with the augmented flyer 470, including adding items in the augmented flyer 470 to an order.

The data collection module 210 may collect data associated with the interaction data 480. In some embodiments, the augmented flyer 470 may include options for providing feedback (e.g., a thumb up or a thumb down) related to the user-interactable elements. For example, in response to clicking a user-interactable element, the augmented flyer 470 may display a mismatched item. The user can, via the client device 470, provide feedback indicating the mismatched item. Such feedback can be used to refine the item matching model 440. In some embodiments, the augmented flyer 470 is an augmentation of a digital flyer generated by the flyer creation module 240. Accordingly, the interaction data 480 may also be used to inform the flyer creation process in a feedback loop.

### Example Methods

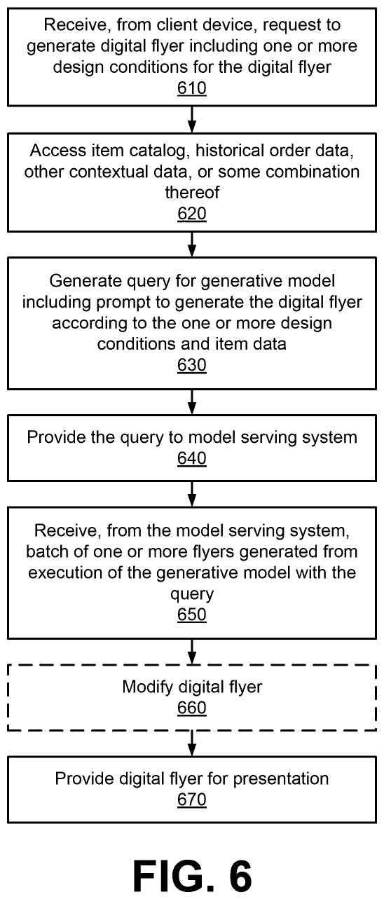

FIG. 6 is a method flowchart for generating flyers using generative machine-learned models, in accordance with some embodiments. Alternative embodiments may include more, fewer, or different steps from those illustrated in FIG. 6, and the steps may be performed in a different order from that illustrated in FIG. 6. These steps may be performed by an online system (e.g., online system 140). Additionally, each of these steps may be performed automatically by the online system without human intervention.

The online system 140 receives 610, from a client device, a request to generate a digital flyer, wherein the request includes one or more design conditions for the digital flyer. The client device may be associated with an administrator of a retailer. The design conditions may be cornerstone items to build the flyer around, a theme, color palette, a brand, etc. The request may further specify a template flyer to use, e.g., with a target layout.

The online system 140 accesses 620 an item catalog storing item data, historical order data, contextual data, or some combination thereof. The item catalog stores data objects relating to items offered by the retailer. The item catalog may further include available promotions, ordering trends, etc. The contextual data may include a current season, upcoming holidays or events, etc.

The online system 140 generates 630 a query for a generative model including a prompt to generate the digital flyer, the one or more design conditions, and item data accessed from the item catalog. In some embodiments, the generative model is connected to the item catalog and can pull the item data directly from the item catalog.

The online system 140 provides 640 the query to a model serving system for execution by the generative model. In some embodiments, the generative model is locally-stored on the online system 140.

The online system 140 receives 650, from the model serving system, a batch of one or more digital flyers generated by executing the generative model on the query. The batch of flyers may provide optionality for the administrator to choose from. The online system 140 may provide the batch to the administrator's client device for selection and/or modification.

In one or more embodiments, the online system 140 may modify the digital flyer. The online system 140 may receive input indicating modifications to make to a digital flyer. The online system 140 may generate a subsequent query to the generative model specifying the modifications. The query is presented to the generative model in conjunction with the flyer to be modified, and the generative model returns a modified version.

The online system 140 provides the digital flyer for presentation. For example, the digital flyer can be presented on a client device associated with a requesting user of the online system 140. In other embodiments, the digital flyer may be printed out onto a physical medium.

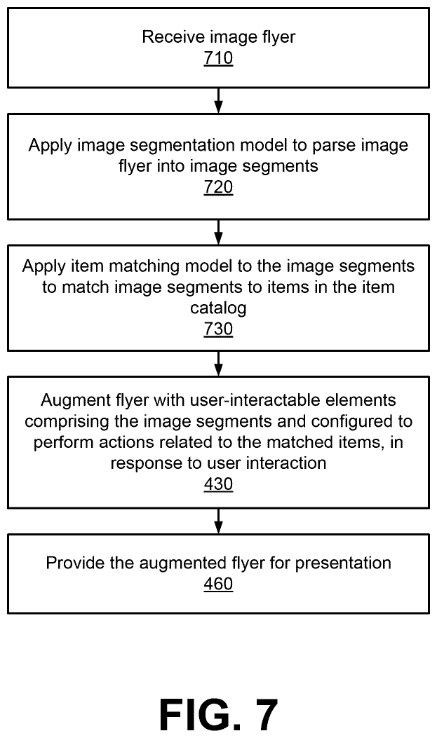

FIG. 7 is a method flowchart for automating the generation of augmented flyers using one or more machine-learned models, in accordance with some embodiments. Alternative embodiments may include more, fewer, or different steps from those illustrated in FIG. 7, and the steps may be performed in a different order from that illustrated in FIG. 7. These steps may be performed by an online system (e.g., online system 140). Additionally, each of these steps may be performed automatically by the online system without human intervention.

The online system 140 receives 710 an image flyer. The image flyer may be provided by a retailer or generated by a generative model.

The online system 140 applies 720 an image segmentation model to the first digital flyer to parse the first digital flyer into a plurality of image segments. The image segmentation model may further classify each image segment into one of a plurality of segment categories. Segment categories may include one segment category relating to images of items, another segment category for a header, a third segment category for item information in text form, etc.

The online system 140 applies 730 an item matching model to each image segment classified into the segment category relating to images of items to match the image segment to an item in the item catalog. The item matching model may use object recognition with the image segments relating to images of items and/or natural language processing algorithm to identify items described in image segments composed of text description of items depicted.

The online system 140 augments 740 the flyer with user-interactable elements. The user-interactable element includes an image segment classified into the segment category relating to images of items and is configured to, responsive to a user interaction with the image segment, perform one or more actions related to the item matched to the image segment. Example actions include present additional details relating to the item matched to the image segment; provide an option to add the item matched to the image segment to an order; provide an option to view one or more similar items to the item matched to the image segment; provide an option to view one or more recipes using the item matched to the image segment; or present an available promotion for the item matched to the image segment.

The online system 140 provides 750 the augmented flyer for presentation to a user via a client device.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A computer-implemented method comprising:
receiving, from a client device, a request to generate a digital flyer, wherein the request includes one or more design conditions for the digital flyer;
accessing an item catalog storing item data;
generating a query for a machine-learned generative model including a prompt to generate the digital flyer, the one or more design conditions, and the item data accessed from the item catalog;
providing the query to a model serving system for execution by the machine-learned generative model;
receiving, from the model serving system, a batch of one or more digital flyers generated by executing the machine-learned generative model on the query; and
providing a first digital flyer in the batch of the one or more digital flyers for presentation to a user.

2. The computer-implemented method of claim 1, wherein a first design condition includes one or more cornerstone items of a retailer in the digital flyer, and wherein generating the query comprises generating the query to include instructions to promote the cornerstone items indicated in the first design condition.

3. The computer-implemented method of claim 1, wherein a first design condition includes a theme for the digital flyer indicating a season, a holiday, or an event, and wherein generating the query comprises generating the query to include instructions to generate the digital flyer according to the theme.

4. The computer-implemented method of claim 1, wherein the request includes a template flyer, and wherein generating the query comprises generating the query to include instructions to use a layout of the template flyer.

5. The computer-implemented method of claim 1, wherein accessing the item catalog comprises accessing the item catalog to retrieve information on available promotions on a subset of the items represented in the item catalog.

6. The computer-implemented method of claim 1, further comprising:
obtaining historical order data describing past orders by users of the online system, each past order including one or more items in the item catalog,
wherein generating the query comprises generating the query to include the historical order data.

7. The computer-implemented method of claim 1, further comprising:
providing, to the client device, the batch of the one or more digital flyers; and
receiving, from the client device, a selection of the first digital flyer, wherein providing the first digital flyer for presentation is based on the selection.

8. The computer-implemented method of claim 7, further comprising:
receiving, from the client device, one or more modifications to the first digital flyer;
generating a subsequent query including a prompt to modify the first digital flyer according to the received one or more modifications; and
providing the subsequent query to the model serving system for execution by the generative model; and
receiving, from the model serving system, a modified version of the first digital flyer generated by executing the generative model on the subsequent query, wherein providing the first digital flyer for presentation comprises providing the modified version of the first digital flyer for presentation.

9. The computer-implemented method of claim 1, wherein the machine-learned generative model is a multimodal model.

10. The computer-implemented method of claim 1, further comprising:
applying an image segmentation model to the first digital flyer to parse the first digital flyer into a plurality of image segments, wherein each image segment is classified into one of a plurality of segment categories including one segment category relating to images of items;
applying an item matching model to each image segment classified into the segment category relating to images of items to match the image segment to an item in the item catalog; and
augmenting the first digital flyer with one or more user-interactable elements, wherein each user-interactable element includes an image segment classified into the segment category relating to images of items and is configured to, responsive to a user interaction with the image segment, perform one or more actions related to the item matched to the image segment,
wherein providing the first digital flyer for presentation comprises providing the augmented first digital flyer for presentation.

11. The computer-implemented method of claim 10, wherein applying the item matching model comprises:
applying an object recognition algorithm to the image segment and the image of each item in the item catalog to determine a similarity score between the image segment and the image of the item; and
matching the image segment to the item in the item catalog with a highest similarity score.

12. The computer-implemented method of claim 11, wherein applying the item matching model further comprises:
applying a natural language processing algorithm to an image segment classified into another segment category relating to item information in text form to identify one or more items in the item catalog described by the item information; and
matching the image segment to the item in the item catalog based on the identified one or more items.

13. The computer-implemented method of claim 11, wherein augmenting the first digital flyer comprises augmenting the first digital flyer with one or more user-interactable elements configured to, responsive to user interaction with the image segment:
magnify the image segment;
present additional details relating to the item matched to the image segment;
provide an option to add the item matched to the image segment to an order;
provide an option to view one or more similar items to the item matched to the image segment;
provide an option to view one or more recipes using the item matched to the image segment; or
present an available promotion for the item matched to the image segment.

14. A non-transitory computer-readable storage medium storing instructions that, when executed by a computer processor, cause the computer processor to perform operations comprising:
receiving, from a client device, a request to generate a digital flyer, wherein the request includes one or more design conditions for the digital flyer;
accessing an item catalog storing item data;
generating a query for a machine-learned generative model including a prompt to generate the digital flyer, the one or more design conditions, and the item data accessed from the item catalog;
providing the query to a model serving system for execution by the machine-learned generative model;
receiving, from the model serving system, a batch of one or more digital flyers generated by executing the machine-learned generative model on the query; and
providing a first digital flyer in the batch of the one or more digital flyers for presentation to a user.

15. The non-transitory computer-readable storage medium of claim 14, the operations further comprising:
providing, to the client device, the batch of the one or more digital flyers; and
receiving, from the client device, a selection of the first digital flyer, wherein providing the first digital flyer for presentation is based on the selection.

16. The non-transitory computer-readable storage medium of claim 15, the operations further comprising:
receiving, from the client device, one or more modifications to the first digital flyer;
generating a subsequent query including a prompt to modify the first digital flyer according to the received one or more modifications; and
providing the subsequent query to the model serving system for execution by the generative model; and
receiving, from the model serving system, a modified version of the first digital flyer generated by executing the generative model on the subsequent query, wherein providing the first digital flyer for presentation comprises providing the modified version of the first digital flyer for presentation.

17. The non-transitory computer-readable storage medium of claim 14, the operations further comprising:
applying an image segmentation model to the first digital flyer to parse the first digital flyer into a plurality of image segments, wherein each image segment is classified into one of a plurality of segment categories including one segment category relating to images of items;
applying an item matching model to each image segment classified into the segment category relating to images of items to match the image segment to an item in the item catalog; and
augmenting the first digital flyer with one or more user-interactable elements, wherein each user-interactable element includes an image segment classified into the segment category relating to images of items and is configured to, responsive to a user interaction with the image segment, perform one or more actions related to the item matched to the image segment,
wherein providing the first digital flyer for presentation comprises providing the augmented first digital flyer for presentation.

18. The non-transitory computer-readable storage medium of claim 17, wherein applying the item matching model comprises:
applying an object recognition algorithm to the image segment and the image of each item in the item catalog to determine a similarity score between the image segment and the image of the item; and
matching the image segment to the item in the item catalog with a highest similarity score.

19. The non-transitory computer-readable storage medium of claim 18, wherein applying the item matching model further comprises:
applying a natural language processing algorithm to an image segment classified into another segment category relating to item information in text form to identify one or more items in the item catalog described by the item information; and
matching the image segment to the item in the item catalog based on the identified one or more items.

20. A computing system comprising:
a computer processor; and
a non-transitory computer-readable storage medium storing instructions that, when executed by the computer processor, cause the computer processor to perform operations comprising:
receiving, from a client device, a request to generate a digital flyer, wherein the request includes one or more design conditions for the digital flyer;
accessing an item catalog storing item data;
generating a query for a machine-learned generative model including a prompt to generate the digital flyer, the one or more design conditions, and the item data accessed from the item catalog;
providing the query to a model serving system for execution by the machine-learned generative model;
receiving, from the model serving system, a batch of one or more digital flyers generated by executing the machine-learned generative model on the query; and
providing a first digital flyer in the batch of the one or more digital flyers for presentation to a user.
